(19) United States
(12) Patent Application Publication
(10) Pub. No.: US 2020/0150601 A1
(43) Pub. Date: May 14, 2020

(54) SOLUTION FOR CONTROLLING A TARGET SYSTEM

(71) Applicant: Curious AI Oy, HELSINKI (FI)

(72) Inventor: Harri VALPOLA, HELSINKI (FI)

(21) Appl. No.: 16/678,179

(22) Filed: Nov. 8, 2019

(30) Foreign Application Priority Data
Nov. 9, 2018 (FI) 20185956

(51) Int. Cl. G05B 13/04; G05B 13/02; G06N 3/04; G06N 3/08; G06N 20/20

(52) U.S. Cl. CPC G05B 13/048; G05B 13/027; G06N 20/20; G06N 3/08; G06N 3/0454

(57) ABSTRACT

Disclosed is a method for controlling a target system, the method including: receiving data of at least one source system, training a first machine learning model component with the received data to generate a prediction on a state of the target system, generating an uncertainty estimate of the prediction, training a second machine learning model machine learning component with the received data to generate a calibrated uncertainty estimate of the prediction; and the method further including: receiving an operational data of the target system, controlling the target system by way of selecting a control action by optimization using the first machine learning model component and arranging to apply the calibrated uncertainty estimate generated with the second machine learning model component in the optimization.

### TECHNICAL FIELD

The invention concerns in general a technical field of control systems. More particularly, the invention concerns a solution for controlling a target system.

### BACKGROUND

Machine learning methods and lately especially neural networks and so-called “deep learning” methods are utilized widely in modern technology, for example in machine vision, pattern recognition, robotics, control systems and automation. In such applications machine learning is used in computer-implemented parts of a system or a device for processing input data.

Model predictive control (MPC) methods are used in numerous control applications in robotics, control systems and automation. In MPC methods, a model of the controlled process is used to predict the process state and the effect of control signals to the process, and control signals can then be generated based on the model. Machine learning methods, for example based on artificial neural networks, can be used to generate, i.e. to construct, a model of a process based on observed input and output signals of the process. This has the advantage that a large number and kind of processes can be modelled in this way, and the modelling can be even automatically redone completely or incrementally to keep the model up to date if the modelled process changes.

However, even though this methodology can be used to generate a model of a system, the models constructed in this way are often unsuitable for prediction or control applications. This is because the models, being automatically generated, are very complex and internally noisy, nonlinear mappings from input signals to output signals, and are not guaranteed to produce sensible outputs with all inputs. One specific problem is that if control actions are planned by optimizing the outcome predicted by a model, mathematical optimization methods can often find points in input space which the model predicts to have a very good outcome, but which are actually only artefacts of the model, and do not correspond to dynamics of the real-world process. Thus it is uncertain if the model predictions and possible corresponding planned control actions are correct, or what are the confidence intervals of the predicted results.

The target process may have inherent stochasticity, training data of the model can be limited so that an unexplored operating point is entered, or something unexpected may happen during the process that is impossible to predict.

There is thus uncertainty in the outputs of a model. This uncertainty can be categorized into two types:
Type 1 (“aleatoric”): Uncertainty that has been observed in the training data, e.g. random noise in the input signals.
Type 2 (“epistemic”): Uncertainty that has not been observed in the training data; e.g. a new process state or operating point.

In case of a Type 1 uncertainty, the uncertainty in the prediction results from stochasticity inherent in the training data.

In case of a Type 2 uncertainty, the uncertainty generally cannot be estimated using statistical methods, as the problem is not stochasticity in the target process, but the internal modeling shortcomings in the model. Estimating this component of uncertainty of the outputs would require the model to detect unfamiliar states and actions, and to reflect that in the estimation of the prediction uncertainty.

Traditionally, data-driven methods (such as neural networks) tend to underestimate uncertainty for previously unseen data, meaning that they ‘overfit’ to seen data but lack extrapolative power that e.g. first principles models (e.g. those based on laws of physics, chemistry etc.) or some empirical models may have. While such first principles models are usually robust, even they may produce unreliable outputs when assumptions they were constructed with don't hold (e.g. errors in input data caused by a broken sensor, or an exceptional process operating point).

In order to use neural network models for controlling a target system it is important to be able to estimate the uncertainty related to the model outputs, so that e.g. in the control solutions the validity and reliability of the control decisions can be predicted. Thus, there is need to develop mechanisms by means of which it is possible at least in part to improve controlling of systems.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a computer implemented method, a control system and a computer program product for control operation.

The objectives of the invention are reached by a computer implemented method, a control system and a computer program product as defined by the respective independent claims.

According to a first aspect, a computer-implemented method for controlling a target system based on operational data of the target system is provided, the method comprising: receiving first data of at least one source system; training a first machine learning model component of a machine learning system with the received first data, the first machine learning model component is trained to generate a prediction on a state of the target system; generating an uncertainty estimate of the prediction; training a second machine learning model component of the machine learning system with second data, the second machine learning model component is trained to generate a calibrated uncertainty estimate of the prediction; the method further comprising: receiving an operational data of the target system; controlling the target system in accordance with the received operational data of the target system by means of selecting a control action by optimization using the first machine learning model component and arranging to apply the calibrated uncertainty estimate generated with the second machine learning model component in the optimization.

The uncertainty estimate of the prediction may be generated by one of the following: the first machine learning model component, the second machine learning model component, an external machine learning model component.

Furthermore, the second machine learning model component of the machine learning system may be trained to generate the calibrated uncertainty estimate of the prediction in response to a receipt, as an input to the second machine learning component, the following: the prediction on the state of the target system, the uncertainty estimate of the prediction, and an output of at least one anomaly detector. The anomaly detector may be trained with the first data of at least one source system for detecting deviation in the operational data.

For example, the source system may be the same as the target system. Alternatively or in addition, the source system may be a simulation model corresponding to the target system. Still further, the source system may be a system corresponding to the target system.

The first machine learning model component may be one of the following: a neural network, a denoising neural network, a generative adversarial network, a variational autoencoder, a ladder network, a recurrent neural network, a random forest.

The second machine learning model component may be one of the following: a neural network, a denoising neural network, a generative adversarial network, a variational autoencoder, a ladder network, a recurrent neural network, a random forest.

Still further, the second data may be one of the following: the first data; out-of-distribution data. The out-of-distribution data, in turn, may be generated by one of the following: corrupting the first ma-chine learning model component parameters and generating the out-of-distribution data by evaluating the corrupted first machine learning model component; applying abnormal or randomized control signals to the target system; clustering the first data by process states or operating points.

According to a second aspect, a control system for controlling a target system (based on operational data of the target system is provided, the control system is arranged to: receive first data of at least one source system; train a first machine learning model component of a machine learning system with the received first data, the first machine learning model component is trained to generate a prediction on a state of the target system; generate an uncertainty estimate of the prediction; train a second machine learning model component of the machine learning system with second data, the second machine learning model component is trained to generate a calibrated uncertainty estimate of the prediction; the control system is further arranged to: receive an operational data of the target system; control the target system in accordance with the received operational data of the target system by means of selecting a control action by optimization using the first machine learning model component and arranging to apply the calibrated uncertainty estimate generated with the second machine learning model component in the optimization.

The control system may be arranged to generate the uncertainty estimate of the prediction by one of the following: the first machine learning model component, the second machine learning model component, an external machine learning model component.

Moreover, the control system may be arranged to train the second machine learning model component of the machine learning system to generate the calibrated uncertainty estimate of the prediction in response to a receipt, as an input to the second machine learning component, the following: the prediction on the state of the target system, the uncertainty estimate of the prediction, and an output of at least one anomaly detector.

The control system may be arranged to train the anomaly detector with the first data of at least one source system for detecting deviation in the operational data.

The first machine learning model component may be one of the following: a neural network, a denoising neural network, a generative adversarial network, a variational autoencoder, a ladder network, a recurrent neural network, a random forest.

The second machine learning model component may be one of the following: a neural network, a denoising neural network, a generative adversarial network, a variational autoencoder, a ladder network, a recurrent neural network, a random forest.

Still further, the second data may be one of the following: the first data; out-of-distribution data. The control system may be arranged to generate the out-of-distribution data by one of the following: corrupting the first machine learning model component parameters and generating the out-of-distribution data by evaluating the corrupted first machine learning model component; applying abnormal or randomized control signals to the target system; clustering the first data by process states or operating points.

According to a third aspect, a computer program product is provided, the computer program product comprising at least one computer-readable media having computer-executable program code instructions stored therein for performing the method as described above when the computer program product is executed on a computer.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an environment in which the present invention may be implemented to.

FIG. 2 illustrates schematically a control system according to an embodiment of the invention.

FIG. 3 illustrates schematically a machine learning system according to an embodiment of the invention.

FIG. 4 illustrates schematically a method according to an embodiment of the invention.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

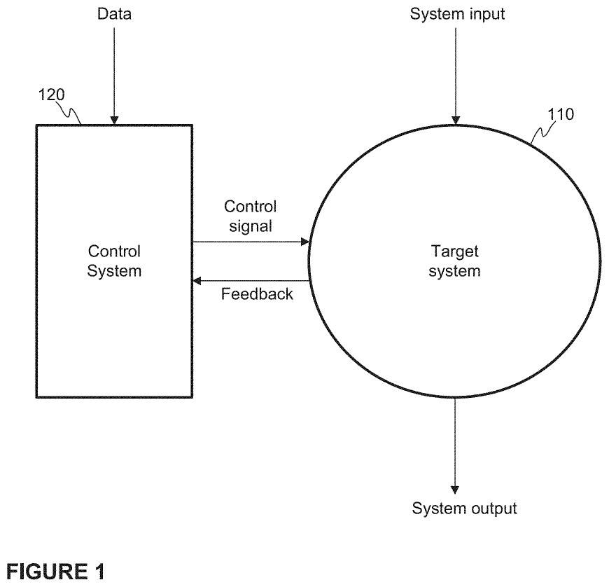

In order to describe at least some aspects of the present invention according to at least one embodiment it is hereby assumed that a target system is controlled with a control system e.g. in a manner as described in FIG. 1. There the target system under control is referred with 110. The target system 110 may e.g. be any process, such as a chemical process, or any other type of system arranged to perform a certain task. The control system 120 may be configured to generate control signals, i.e. to perform controlling, to the target system 110 e.g. in accordance with feedback information received from the target system 110. The target system 110 may receive its input from an external source. The input shall be understood in broad terms e.g. referring to input data or input material to the system. As said the target system 110 may be arranged to perform a certain task and to generate system output accordingly. According to the present invention the control system 120 may be implemented, at least in part, with a machine learning system comprising a number of machine learning model components, which is trained to perform its task for the control system 120. The training may be performed by inputting data also called as training data, e.g. being relevant to the target system. The training data may e.g. relate to some data obtained from the target system under control or from any corresponding source system. Alternatively or in addition, the source system may refer to a system which is a simulation model of the target system 110. In other words, the training data may be obtained from a source system that corresponds to the target system 110 with a predetermined accuracy or the source system may be the target system 110 itself wherein the training data may e.g. be historical data of the target system 110. The data may comprise e.g. internal data representing an operation of the source system, such as state information of the source system. In FIG. 1 the target system 110 and the control system 120 are illustrated as distinct entities, but they may also be implemented in a same entity.

For understanding the description of the invention as is described herein it is worthwhile to mention that feedback information received from the target system 110 for generating the controlling by the control system 120 may refer to operational data. Hence, the operational data represent either directly or indirectly an operation of the target system 110, such as state information of the target system 110 e.g. at an instant of time. As a non-limiting example of the operational data it may be mentioned measurement data from the system, wherein the measurement data may e.g. be obtained with one or more sensors. It is worthwhile to mention that the operational data may comprise control information from past, control information currently applied to the target system and/or planned control signals for future use.

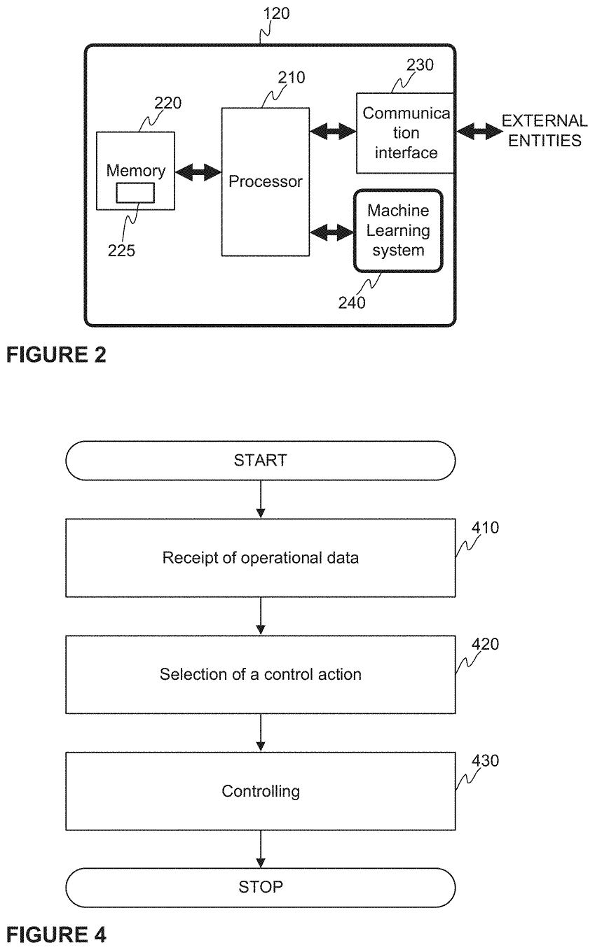

A non-limiting example of the control system 120 suitable for performing the controlling of the target system 110 according to an embodiment of the invention is schematically illustrated in FIG. 2. As already mentioned the controlling functionality may be implemented in the control system 120. The control system 120 itself may be implemented, at least in part, with a machine learning system implementation comprising of a number of machine learning model components for the purposes as described and configured to control the target system 110. The control system 120 may comprise a processing unit 210, which may be configured to control an operation of the control system. The processing unit 210 may be implemented with one or more processors, or similar. The control system 120 may also comprise one or more memories 220 and one or more communication interfaces 230. The one or more memories may be configured to store computer program code 225 and any other data, which, when executed by the processing unit 210, cause the control system to operate in the manner as described. The mentioned entities may be communicatively coupled to each other e.g. with a data bus. The communication interface 230, in turn, comprises necessary hardware and software for providing an interface for external entities for transmitting signals to and from the control system 120. In the exemplifying implementation of the control system 120 of FIG. 2 comprises a machine learning system 240 comprising a number of machine learning model components by means of which the controlling functionality as described may be generated. In the example of FIG. 2 the machine learning system 240 is arranged to operate under control of the processing unit 210. In some other embodiment of the present invention the machine learning system 240 generating the controlling functionality, at least in part, may reside in another entity than the control system 120. Furthermore, in some other embodiment the processing unit 210 may be configured to implement the functionality of the machine learning system and there is not necessarily arranged a separate entity as the machine learning system 240.

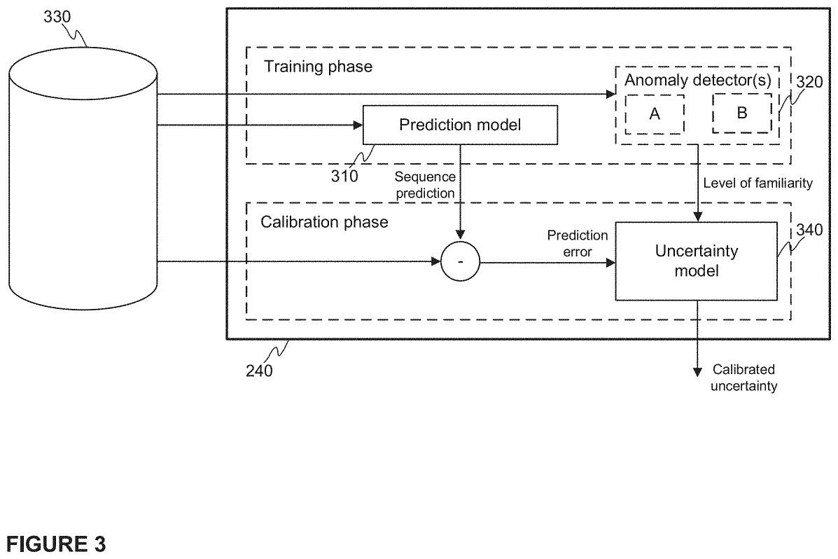

As mentioned the control system 120 according to an embodiment of the invention may be implemented so that a machine learning system 240 is arranged to be involved in a controlling task of the target system 110. The machine learning system 240 may comprise a number of machine learning model components. An example of the machine learning system according to an embodiment of the invention is schematically illustrated in FIG. 3. The machine learning system 240 according to the embodiment may comprise a first machine learning model component 310 which may be trained at least to generate a prediction on a state of a target system 110, but possibly also an uncertainty estimate on the prediction. In some other embodiment the uncertainty estimate on the prediction may be generated by another machine learning model component external to the first machine learning model component 310. The uncertainty estimate on the prediction may be scaled for the need. Some non-limiting examples of applicable neural network models for the first machine learning model component 310 may be: a neural network, a denoising neural network, a generative adversarial network, a variational autoencoder, a ladder network, a recurrent neural network, a random forest. Examples of applicable recurrent neural networks may e.g. be LSTM, GRU and other such networks. Moreover, the machine learning system 240 may comprise a second machine learning model component 340 which may be trained to generate a calibrated uncertainty estimate of the prediction. Some non-limiting examples of applicable neural network models for the second machine learning model component 340 may be: a neural network, a denoising neural network, a generative adversarial network, a variational autoencoder, a ladder network, a recurrent neural network, a random forest. Examples of applicable recurrent neural networks may e.g. be LSTM, GRU and other such networks. As a non-limiting example, the second machine learning model component 340 may be arranged to generate the uncertainty estimate on the prediction among other tasks. In addition to the mentioned elements the machine learning system 240 may comprise at least one anomaly detector 320 for detecting anomalous states of the target system as will be described. The anomaly detector 320 may be included in the solution by generating an anomaly detector output, i.e. comprising input of data to the anomaly detector, triggering computations in the anomaly detector implementation, and receiving anomaly detector results as output. The anomaly detector may be implemented as a machine learning based component, e.g. a neural network model, in which case the evaluation of the anomaly detector may also include the training of the anomaly detector.

The term second machine learning model component shall be, in the context of the present invention, to cover machine learning model comprising one or more layers, such as a multilayer perceptron (MLP) type model having one or more layers. If the second machine learning model component is implemented with one layer only it is a linear combination of the one or more outputs of the one or more anomaly detectors.

The training of the machine learning system 240 of FIG. 2 may be implemented so that it consists of two phases i.e. a training phase and a calibration phase. In the training phase the prediction first machine learning model component 310 may be arranged to receive first data 330 as an input. The received first data 330 may comprise predetermined data from at least one source system as discussed. The data 330 may also be called as training data which may also provide type 1 uncertainty estimates, e.g. from quantiles. The type 1 uncertainty estimates may refer to aleatoric type uncertainty estimates, as a non-limiting example. These uncertainty estimates are only valid within seen data distribution. Hence, the first machine learning model component 310 may be trained with the data so that it may generate a prediction on a state of the target system 110, and also uncertainty estimate of the prediction in an embodiment of the invention. In some other embodiment of the invention, the uncertainty estimate of the prediction may be generated by another machine learning model component, such as by the second machine learning model component 340 as a non-limiting example.

Correspondingly, the second machine learning model component 340 of the machine learning system 240 may be trained with second data 330 as the first machine learning model component 310. The second data may be the same as the first data or, alternatively, the data used for the training of the first and the second machine learning model component may differ from each other at least in part even if they may be stored, at least temporally, in a same data storage, such as in a database. For example, the second data used for training the second machine learning model component 340 may be so-called uncertainty calibration data whose generation may advantageously be arranged to be out-of-distribution from the first data used for training the first machine learning model component. Thus, it would ideally, according to an embodiment of the invention, comprise:
Changes in process dynamics,
“New” operating points or disturbances,
Abnormal controls either in history or future.

The so-called uncertainty calibration data may be generated by various methods. For example, uncertainty calibration data may be generated by applying abnormal or randomized control signals to the target system 110, or a real or simulated source system corresponding to the target system 110. As another non-limiting example, process history data corresponding to different control signals, process states or operating points may be divided i.e. clustered for use as either uncertainty calibration data or training data, so that the uncertainty calibration data corresponds to at least some control signals, process states or operating points that are not represented in the training data. As another example, out-of-distribution data can be generated using the trained first machine learning model component 310, by using the prediction model to stand in for the process and applying abnormal or randomized control signals. Out-of-distribution data may also be generated by making changes, e.g. adding random noise, to the trained first machine learning model component 310 i.e. the prediction model, parameters, and using the changed first machine learning model components to simulate the process and generate data, which will then be out-of-distribution of the trained first machine learning model component 310, and therefore differently from the target process the trained first machine learning model component was trained to predict. Hence, the uncertainty calibration data may be generated either by a simulator or from process history data. For sake of clarity it is worthwhile to mention that this does not mean that all kinds of changes, operating points or disturbances have to be seen in the calibration data, but rather that some examples provide a means to estimate better the real prediction uncertainty when an anomaly is seen.

Moreover, in an implementation of the present invention in which a separate set of data 330 specific to the second machine learning model component may be employed in training the type 2 uncertainty estimates. As a non-limiting example of the type 2 uncertainty estimates may be epistemic uncertainty estimates. At least one purpose of the training step in the calibration phase may be to provide sensible scaling for the anomaly detector 320 outputs through a generation of a prediction error to the uncertainty model. The prediction error may be determined by subtraction the training data 330 specific to the second machine learning model component from the output of the first machine learning model component 310. In FIG. 3 the subtraction is illustrated as a separate operation, but it may be defined as an internal operation inside the uncertainty model 340. All in all, the scaling, at least, provides better uncertainty estimates for previously unseen data.

The training of the second machine learning model component 340 in the manner as described causes the second machine learning model component 340 to generate a calibrated uncertainty estimate of the prediction.

As mentioned above the machine learning system 240 according to an embodiment of the invention may comprise one or more anomaly detectors 320. The at least one anomaly detector 320 may be trained with the same data 330 as the prediction model, i.e. the first machine learning model component 310, as discussed, or the anomaly detector may be evaluated in the manner as described. According to at least one embodiment the anomaly detector 320 may be arranged to generate corrupted data from the original data 330. According to an embodiment of the invention the corruption does not necessarily have to follow actual process performance outside seen data. The corruption may thus create an “outer layer” to the seen cloud of data points.

More specifically, the one or more anomaly detectors 320 may be trained with the same training data 330 (i.e. the operational data of the source system), which may provide a signal whether the input values are in a known or unknown state. Hence, the anomaly detectors 320 may, among other task, to generate one or more indications if the input data values of the training data are present in a known state or not (i.e. corresponding to unknown state). In practice, the anomaly detectors 320 may be arranged to scan both past measurements and also future predictions. They may be arranged to use short windows (and possibly different timescales/resolutions) so that they may generalize the received data better.

In the following some non-limiting examples of possible anomaly detectors 320 applicable in a context of the present invention are disclosed:
Past prediction performance detector
   Use previous prediction errors as a measure of anomaly
   Baseline, by definition only works for past measurements and past predictions, not for future predictions
“Case-based reasoning” i.e. matching data detector
   E.g. Distance to n nearest past measurement data matches
   Not good for high-dimensional data in naive form
Noise-contrastive detector
   Training data, corrupted (varying levels) training data->train model to detect which and at which level
   As a basic example, the noise can be independent and identically distributed (IID) Gaussian noise, but signal correlations can also be taken into account when creating the noise
Denoising autoencoder detector
   Task is to take corrupted data and predict original clean data
   Then, corrupted signal is compared to the denoised signal and distance of these is the detector output

As is derivable from above through the training procedure of the machine learning system of the control system 120 a prediction of the target process state and an estimate of uncertainty of the prediction may be achieved as an output. The uncertainty may be given e.g. in the form of a probability distribution of the prediction, a quantized approximation of a distribution, or a confidence interval of the prediction.

Next, a controlling of target system 110 may be arranged with a machine learning system 240 as trained in the manner as described. As mentioned the machine learning system 240, according to an embodiment of the invention, may be arranged to generate a calibrated uncertainty as an output of the machine learning system 240. The control system 120 may be arranged to receive operational data 410 of a target system 110, as defined, it is arranged to control in one way or another. At least a portion of the operational data may be input to the trained machine learning system 240. Next, the control system 120 is, by means of the machine learning system 240, arranged to select a control action by optimization using the trained first machine learning model component 310 and arranging to apply the calibrated uncertainty estimate generated with the second machine learning model component 340 in the optimization. In other words, the selection of the control action may be performed by optimization by inputting the received operational data representing an operation of the target system 110 in one way or another for selecting an optimal control action for the target system 110.

The selection of the control action may be made by optimizing the control action against an objective function. The objective function may e.g. be a function of the controlled process state executed by the target system 110, and may be e.g. the profit of a plant, or any similar parameter, over a time period, which may take into account the value of the produced good(s) and the cost of used raw materials, energy, cost of applying controls (e.g. wear and tear on control equipment) etc. The first machine learning model component 310 in the control system 120 may, thus, be used to generate a prediction of the state of the target system 110, and the objective function is evaluated with this predicted state.

In other words,

a=argmax[V(F(x,a))]

where
a is a planned control signal
x is the system state
argmax[ ] refers to finding the argument(s) (here a) that maximises the value of a function (here V)
V is a value (“reward”) function which denotes the value that the controlling is optimizing
F is the prediction model 210.

Solving the optimization (referred to above by argmax) problem of the value function V can be done with any suitable mathematical optimization method generally known, e.g. grid search, stochastic search, gradient descent, backpropagation or other such mathematical optimization method. Variables a and x can be numbers or categorical variables, or multidimensional vectors of values. a and x may be sequences of values, e.g. they may be a time sequence of the past. present and/or planned future actions and system state. V is a function that is used to evaluate the value of the outcome. V may include discounting predicted future values by some multiplier to weigh near-term value more than long-term value.

The calibrated uncertainty may be incorporated, in an embodiment, in the generation of the control signal by incorporating it in the optimization e.g. by:

a=argmax[V(F(x,a))−E]

where E is the calibrated uncertainty.

In another embodiment of the invention in which, for example, the second machine learning model is a trainable coefficient, the control signal may be expressed as

a=argmax[V(F(x,a))+kD]

where D is the anomaly detector output value and k is a trainable parameter which is determined in the training of the machine learning system.

Moreover, V may embody soft and hard limits for the process state, soft limits meaning x close to a soft limit has an increased cost in the objective function, and hard limits meaning that control signals which cause x to violate a hard limit are not allowed to be generated. If the uncertainty estimate is in the form of x being a distribution, or a list of quantiles, V may be a function where each possible x in the distribution is evaluated, so that soft and hard limits are effectively evaluated for each uncertain predicted possible value of x. Optionally, the possible values of x may be weighed with their calibrated uncertainty in the calculation. Uncertainty is then incorporated in the value function, i.e.:

a=argmax[V(F(x,a,E)]

In response to the optimization process as described the control system 120 may perform the selection of the optimal control action and perform controlling 430 of the target system 110 accordingly. The controlling may comprise, but is not limited to, a generation at least one control signal to the target system 110 for achieving the target system 110 to operate in an optimal manner. For example, if the first machine learning model component is a machine learning system 240 which is arranged to predict a temperature in a chemical process, the control system 120 may provide an uncertainty estimate that the predicted temperature is on 3 h later is +−70% uncertain, which may be taken into account in the generation of the controlling to the target system 110.

For sake of clarity it shall be understood that the uncertainty generated with the control system 120 according to an embodiment of the invention is different from usual statistically determined uncertainty in the data, because it includes the uncertainty resulting from the model defining at least part of the control system 120 being inaccurate, not just stochasticity of the data.

As may be derived from the description the determined uncertainty may be used for generating and optimizing control signals e.g. by favoring of control signals where the uncertainty is low. In addition to the generation of the control signals further actions may be taken. According to an embodiment of the invention the control system may be arranged to generate the uncertainty information to an operator of the control system 120 and/or the target system 110. The information may e.g. be output to the operator e.g. visually with a display device. In such a manner it is possible to provide information to the operator e.g. for convincing that the model may be trusted.

Moreover, according to another embodiment it is possible to arrange that in addition to the generation of the control signals an online learning may be aided e.g. by triggering a re-training of the neural network model in response to a detection that the uncertainty exceeds a predetermined limit. The triggering may be automatic, semi-automatic or an operator controllable.

Still further, according to an embodiment of the invention the uncertainty information may be used for selecting whether to automatically apply a control decision (i.e. the generated control signal) by the control system 120, or whether to have the control decision approved by an external system or human operator, based on whether the estimated uncertainty exceeds a predetermined threshold.

Furthermore, some aspects of the present invention may relate to a computer program product comprising at least one computer-readable media having computer-executable program code instructions stored therein that cause, when the computer program product is executed on a computer, such as by a processor of the control system, the generation of the controlling according to the method as described.

Generally speaking, the control system 120 may refer to a distributed computer system, a computer, a circuit or a processor in which the processing of data as described may be performed. Similarly, the operations of the neural network models may be implemented with a single neural network model or with a plurality of distinct models through controlling and configurating the model(s) accordingly.

As a non-limiting example, the target system 110 may be a chemical production or another industrial process plant, where the operational data comprises sensor measurements from different parts of the process (e.g. temperature, pressure, flow rate, voltage, current, camera images) and the control system 120 outputs are control signals, for example setpoint values for temperatures, pressures, flow rates, or physical signals, such as electrical current or voltage signals, etc. The control signals may be setpoint values of other, e.g. lower-level, controllers, such as PID controllers or other hardware or software components. The control signals may be applied automatically to the target system 110, or they may be generated as a suggestion which is then applied to the system by another system or a human operator, e.g. after a review or safety limit checking.

In another non-limiting example, the target system 110 may be an autonomous vehicle or a robotic system, where operational data includes sensor measurements, such as position, orientation, speed, current, voltage, camera images etc., and the control signals may be steering actions, voltage or current signals, commands to a separate autopilot system, picking or manipulation commands, etc.

In a still further non-limiting example, the target system 110 may be an automated document handling system or another IT system, where the operational data includes e.g. digital documents, database records, emails, electrical invoices, web pages etc., and the control actions would be control signals to e.g. classify a document in a certain manner, or any actions performed in an IT system.

In a still further non-limiting example, the target system 110 may be a production line QA (Quality Assurance) system, where the operational data includes sensor measurements from manufactured material or products, e.g. camera images, where a QA system is used to detect e.g. defects in the products. The method according to the invention may then e.g. be used to generate a control signal to move a product aside as a fault risk when the QA system's prediction of product quality has high uncertainty.

In a still further non-limiting example, the target system 110 may be a medical monitoring system, where the operational data includes medical sensors such as heartbeat, EEG, ECG, EKG sensors, blood analyzers outputs etc., and outputted control signals are e.g. alerts to medical personnel, automatic administration of drugs, further tests, electrical stimulation etc.

For sake of clarity it is worthwhile to mention that the term “machine learning model component” refers, in addition to descriptions provided herein, to methods where algorithms or models may be generated based on samples of input and output data by automatic training of the algorithm or model parameters.

Moreover, the machine learning system 240 may refer to an implementation in which a processing unit is arranged to execute a predetermined operation for causing the machine learning system 240, and the component(s) therein, and, hence, the control system 120 to perform as described. The machine learning system may be connected to other systems and data sources via computer networks, and may be arranged to fetch the operational data from other systems for training the machine learning components, which may be triggered by user of the system, or automatically triggered e.g. by regular intervals. The machine learning system may include trained machine learning components as serialized, file-like objects, such as for example trained neural network weight parameters saved as a file. The machine learning parameters may be stored, generated and modified in the machine learning system, or they may be generated in an external system and transferred to the machine learning system for use.

The specific examples provided in the description given above should not be construed as limiting the applicability and/or the interpretation of the appended claims. Lists and groups of examples provided in the description given above are not exhaustive unless otherwise explicitly stated.

1. A non-transitory, computer-readable medium on which is stored a computer program that, when executed by a computer, performs a method for controlling a target system based on operational data of the target system, the method comprising:
receiving first data of at least one source system, training a first machine learning model component of a machine learning system with the received first data, the first machine learning model component is trained to generate a prediction on a state of the target system,
generating an uncertainty estimate of the prediction, training a second machine learning model component of the machine learning system with second data, the second machine learning model component is trained to generate a calibrated uncertainty estimate of the prediction,
the method further comprising:
receiving an operational data of the target system,
controlling the target system in accordance with the received operational data of the target system by means of selecting a control action by optimization using the first machine learning model component and arranging to apply the calibrated uncertainty estimate generated with the second machine learning model component in the optimization.

2. The non-transitory, computer-readable medium of claim 1, wherein the uncertainty estimate of the prediction is generated by one of the following: the first machine learning model component, the second machine learning model component, an external machine learning model component.

3. The non-transitory, computer-readable medium of claim 1, wherein the second machine learning model component of the machine learning system is trained to generate the calibrated uncertainty estimate of the prediction in response to a receipt, as an input to the second machine learning component, the following:
the prediction on the state of the target system,
the uncertainty estimate of the prediction, and
an output of at least one anomaly detector.

4. The non-transitory, computer-readable medium of claim 3, wherein the anomaly detector is trained with the first data of at least one source system for detecting deviation in the operational data.

5. The non-transitory, computer-readable medium of claim 1, wherein the source system is the same as the target system.

6. The non-transitory, computer-readable medium of claim 1, wherein the source system is a simulation model corresponding to the target system.

7. The non-transitory, computer-readable medium of claim 1, wherein the source system is a system corresponding to the target system.

8. The non-transitory, computer-readable medium of claim 1, wherein the first machine learning model component is one of the following: a neural network, a denoising neural network, a generative adversarial network, a variational autoencoder, a ladder network, a recurrent neural network, a random forest.

9. The non-transitory, computer-readable medium of claim 1, wherein the second machine learning model component is one of the following: a neural network, a denoising neural network, a generative adversarial network, a variational autoencoder, a ladder network, a recurrent neural network, a random forest.

10. The non-transitory, computer-readable medium of claim 1, wherein the second data is one of the following: the first data; out-of-distribution data.

11. The non-transitory, computer-readable medium of claim 10, wherein the out-of-distribution data is generated by one of the following: corrupting the first machine learning model component parameters and generating the out-of-distribution data by evaluating the corrupted first machine learning model component; applying abnormal or randomized control signals to the target system; clustering the first data by process states or operating points.

12. A control system for controlling a target system based on operational data of the target system, the control system is arranged to:
receive first data of at least one source system,
train a first machine learning model component of a machine learning system with the received first data, the first machine learning model component is trained to generate a prediction on a state of the target system,
generate an uncertainty estimate of the prediction,
train a second machine learning model component of the machine learning system with second data, the second machine learning model component is trained to generate a calibrated uncertainty estimate of the prediction,
the control system is further arranged to:
receive an operational data of the target system,
control the target system in accordance with the received operational data of the target system by means of selecting a control action by optimization using the first machine learning model component and arranging to apply the calibrated uncertainty estimate generated with the second machine learning model component in the optimization.

13. The control system of claim 12, wherein the control system is arranged to generate the uncertainty estimate of the prediction by one of the following: the first machine learning model component, the second machine learning model component, an external machine learning model component.

14. The control system claim 12, wherein the control system is arranged to train the second machine learning model component of the machine learning system to generate the calibrated uncertainty estimate of the prediction in response to a receipt, as an input to the second machine learning component, the following:
the prediction on the state of the target system,
the uncertainty estimate of the prediction, and
an output of at least one anomaly detector.

15. The control system of claim 14, wherein the control system is arranged to train the anomaly detector with the first data of at least one source system for detecting deviation in the operational data.

16. The control system of claim 12, wherein the first machine learning model component is one of the following: a neural network, a denoising neural network, a generative adversarial network, a variational autoencoder, a ladder network, a recurrent neural network, a random forest.

17. The control system of claim 12, wherein the second machine learning model component is one of the following: a neural network, a denoising neural network, a generative adversarial network, a variational autoencoder, a ladder network, a recurrent neural network, a random forest.

18. The control system of claim 12, wherein the second data is one of the following: the first data; out-of-distribution data.

19. The control system of claim 18, wherein the control system is arranged to generate the out-of-distribution data by one of the following: corrupting the first machine learning model component parameters and generating the out-of-distribution data by evaluating the corrupted first machine learning model component; applying abnormal or randomized control signals to the target system; clustering the first data by process states or operating points.

20. (canceled)

21. The non-transitory, computer-readable medium of claim 2, wherein the second machine learning model component of the machine learning system is trained to generate the calibrated uncertainty estimate of the prediction in response to a receipt, as an input to the second machine learning component, the following:
the prediction on the state of the target system,
the uncertainty estimate of the prediction, and
an output of at least one anomaly detector.
